(19) United States
(12) Patent Application Publication
(10) Pub. No.: US 2019/0136937 A1
(43) Pub. Date: May 9, 2019

(54) Adjustable Damping Valve Device For A Vibration Damper

(71) Applicant: ZF FRIEDRICHSHAFEN AG, Friedrichshafen (DE)

(72) Inventors: Romano KESS, Bad Kissingen (DE); Achim SAUERBREY, Schweinfurt (DE)

(73) Assignee: ZF FRIEDRICHSHAFEN AG, Friedrichshafen (DE)

(21) Appl. No.: 16/090,972

(22) PCT Filed: Mar. 6, 2017
(86) PCT No.: PCT/EP2017/055111

§ 371 Date: Oct. 3, 2018

(30) Foreign Application Priority Data
Apr. 6, 2016 (DE) 10 2016 205 651.4

(51) Int. Cl. F16F 9/46; F16K 47/04

(52) U.S. Cl. CPC F16F 9/464; F16K 47/04; F16F 2230/00; F16F 2226/042; F16F 2226/04; F16F 2228/066

(57) ABSTRACT

A damping valve device having at least one damping valve which is adjustable via an actuator. The actuator has a coil and a back iron which is separate from a valve housing for a magnetic flux circuit. The back iron is fixed in radial direction inside the valve housing so as to be free of play.

### CROSS REFERENCE TO RELATED APPLICATIONS

This is a U.S. national stage of application No. PCT/EP2017/055111, filed on Mar. 6, 2017. Priority is claimed on German Application No. DE102016205651.4, filed Apr. 6, 2016, the content of which is incorporated here by reference.

### BACKGROUND OF THE INVENTION

### 1. Field of the Invention

The invention is directed to a damping valve.

### 2. Detailed Description of the Prior Art

DE 10 2014 215 563 A1 describes an adjustable damping valve device that comprises an electromagnetically operated actuator. A coil in connection with a disk-shaped back iron and an armature connected to a valve body forms a circuit for a magnetic flux. To adjust the damping force, the magnetic flux circuit carries a pulse-width-modulated current (PWM) to adopt a defined operating position over a time window to generate a greater damping force. The back iron is axially fixed but forms a clearance fit with an inner wall of a valve housing fixed to a piston rod.

A basic problem in an adjustable damping valve device is that noises occur in operation and these noises can also be perceived inside the vehicle. In general, the noises occur as a result of sudden fluctuations in pressure inside of the vibration damper. For example, it has been discovered that a sudden change in damping force, for example, from a high damping force setting to a low damping force setting, leads to an unpleasant noise. This noise is produced by component parts decompressing in the vibration damper.

Often, noises caused by the flow of damping medium will also occur. It is known that noises occur when a damping valve is switched from a through position to a closed position and a valve body accordingly strikes a seat surface with a comparatively high force. Virtually all problems more or less stem from hydraulic and/or mechanical causes.

There are also rattling noises, for example, which can occur during the operation of the vibration damper and for which no solution has been found heretofore.

### SUMMARY OF THE INVENTION

An object of one aspect of the present invention is to find a solution to the noise problems, which is met in that the back iron is fixed in radial direction inside the valve housing so as to be free of play.

The frequency of the PWM of the coil control lies within the resonant frequency range of the piston rod. It has been discovered through extensive investigation that the vibration forms as wave on the tubular piston rod. The piston rod forms the elasticity and the damping valve device forms the mass or only the valve housing forms the mass of the system. As regards the clearance fit, the back iron has an undefined gap relative to the magnet housing. In the statistically most common case, the back iron slides with a one-sided contact with the inner wall of the valve housing during assembly. In the final assembled position, the back iron is oriented to a base surface of the valve housing. If the first contact point of the back iron on the base surface is located in proximity to the contact of the lateral surface, the back iron tilts over this point so that a micro-gap results at the lateral surface relative to the inner wall. As a result of magnetostriction, the back iron begins to vibrate radially. This effect is further strengthened if the back iron is slotted and accordingly has good elasticity in this area. Because of the vibration, the back iron knocks against the valve housing at resonant frequency. Accordingly, an impulse is introduced and the piston rod vibrates increasingly at resonant frequency. However, if the back iron is radially fixed, the micro-gap is permanently closed and the back iron is linked to the large mass of the valve housing. Thus, the PWM cannot permanently accelerate the large mass comprising valve housing and piston rod. Consequently, there is no rattling noise proceeding from the actuator.

In a particularly simple embodiment form, the back iron forms an interference fit with an inner wall of the valve housing. The interference fit need not be designed to transmit large forces. It only suffices to prevent a micro-clearance relative to the valve housing.

To maintain a simple assembly and prevent stress on the valve housing though chip abrasion, the valve housing has a fitting surface which is offset relative to the rest of the inner wall.

In a further advantageous embodiment, the back iron has areas with different radial elasticity, and the interference fit is formed by the area with the greatest radial elasticity. The spring characteristic of the back iron is made use of in order also to compensate for manufacturing variations.

According to an advantageous subclaim, the interference fit is formed by a lateral surface region of the back iron that extends from an end area of the back iron. There is a clearance fit outside of the lateral surface region such that the back iron can easily slide into the predetermined final assembly position.

It can also be provided that the back iron and the valve housing form a cone connection. The cone connection also constitutes a form of interference fit. The back iron is centered without play even with a slight axial load.

For example, the cone connection can be formed by a lateral surface of the back iron extending in circumferential direction. It can be determined by the cone angle whether or not the back iron is held by self-retention after a closing force regardless of an axial load in the valve housing.

Alternatively, the self-centering can also be formed via a cone connection of an end face of the back iron. The advantage consists in that the cone surface at the base surface of the valve housing can be produced very easily by a simple stamping process.

Alternatively, or in combination with other solutions, the back iron can be fixed in the valve housing by a glue connection. In this case also, a glue connection need not transmit significant forces but should only prevent a radial movement of the back iron.

In a further embodiment form, separate fasteners are arranged between the valve housing and the back iron.

The fasteners are preferably formed by a screw valve that serves as a vent valve of the damping valve device.

### BRIEF DESCRIPTION OF THE DRAWINGS

The invention will be explained in more detail referring to the following description of the figures.

The drawings show:

FIG. 1 is a sectional view of a damping valve;

FIGS. 2-4 are a back iron as individual part;

FIGS. 5 and 6 are a cone connection of the back iron to the valve housing;

FIG. 7 is a glue connection between back iron and valve housing; and

FIG. 8 is a fastener between back iron and valve housing.

### DETAILED DESCRIPTION OF THE PRESENTLY PREFERRED EMBODIMENTS

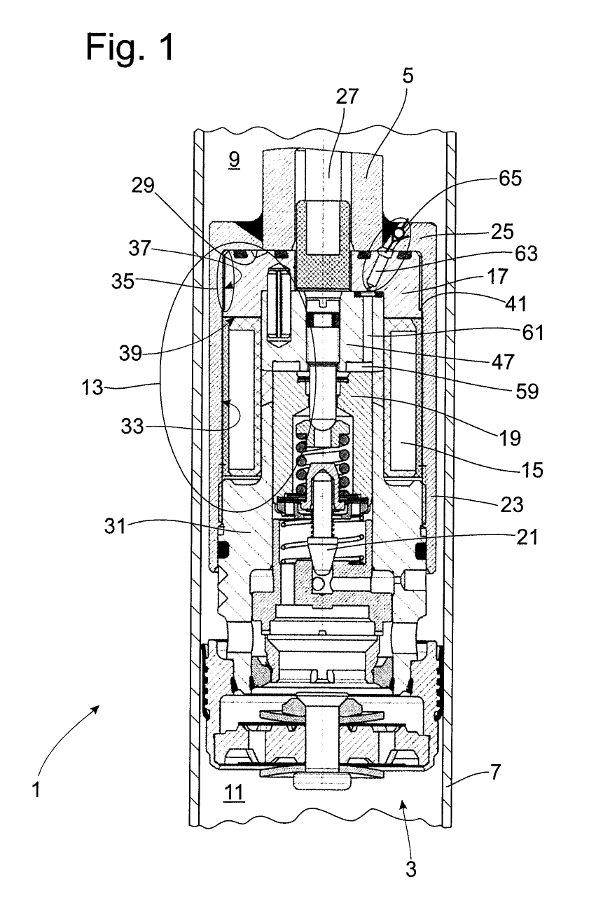

FIG. 1 shows a section from a vibration damper 1 in the area of an adjustable damping valve device 3 which is fastened to a piston rod 5. The piston rod 5 is axially movably guided inside a cylinder 7 filled with damping medium. The damping valve device 3 divides the cylinder 7 into a working chamber 9 on the piston rod side and a working chamber 11 remote of the piston rod.

The damping valve device 3 comprises an actuator 13 that exerts a magnetic force on an armature 19 via a coil arrangement 15 and a back iron 17. The armature 19 is in turn operatively connected to a valve body 21. The specific construction of the valve body 21 and of the further valves is not relevant to the invention that can also be applied in simpler embodiment forms. Reference is made to DE 198 22 448 A1 with regard to the manner of functioning of the valve technology.

The damping valve device 3 comprises a valve housing 23 with a base 25 via which the valve housing 23 is connected to the piston rod 5. The piston rod 5 is constructed so as to be tubular and receives a power cable 27 for a coil arrangement 15. The back iron 17 is clamped in axial direction between an inside base surface 19 of the base 25 and the coil arrangement 15. A coil support 31 is connected to the valve housing 23 and provides for the required preloading on the coil arrangement 15.

The back iron 17 is fixed without play in radial direction inside the valve housing 23. This prevents the back iron 17 from being set in radial vibration due to the high-frequency operation of the coil arrangement and transmitting this vibration to the piston rod 5. In FIG. 1, the back iron 17 forms an interference fit 35 with an inner wall 33 of the valve housing. To this end, the valve housing 23 has a fitting surface 37. However, the fitting surface 37 is radially offset with respect to the rest of the inner wall 33 so that the entire inner wall need not be machined to the same manufacturing level as the fitting surface 37. As can be seen from FIG. 1 which is not shown to scale in this area, the fitting surface 37 has a slightly smaller inner diameter than the inner wall 33 in the area of the coil arrangement 15.

The back iron 17 has a diameter expansion 41, not shown to scale, proceeding from an end area 39 so that the interference fit 35 is formed only by a lateral surface area.

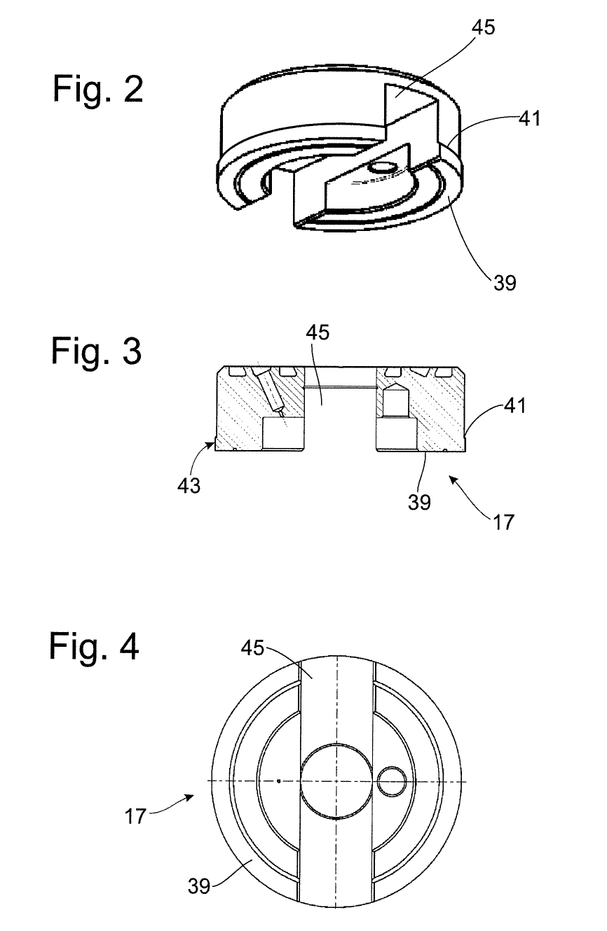

FIGS. 2 to 4 show the back iron 17 as an individual part. A transverse groove 45 which is also visible in FIG. 1 and receives a magnetically conducting pole element 47 is clearly visible. The back iron has the greatest radial elasticity in the area of the transverse groove 45. Therefore, the lateral surface region 43 forming the interference fit 35 is also preferably formed in this area.

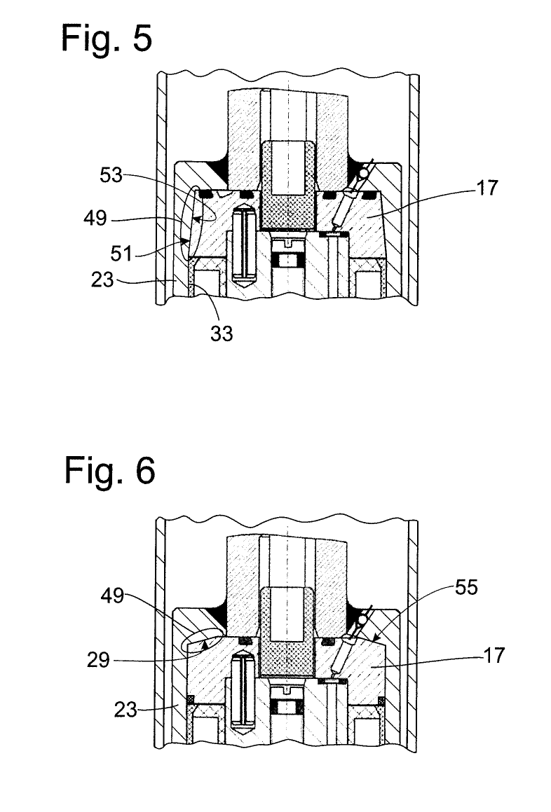

FIG. 5 shows an embodiment form in which the back iron 17 and the inner wall 33 of the valve housing form a cone connection 49. The back iron 17 has, in circumferential direction, a conical lateral surface 51 that engages in a cone surface 53 of the inner wall. Accordingly, the back iron 17 is centered radially without play with respect to the inner wall 33.

FIG. 6 shows a modification of FIG. 5. The difference consists in that the cone connection 49 is formed by an end face 55 of the back iron 17 and the base surface 29. As has already been stated referring to FIG. 1, the back iron is axially preloaded. Consequently, the back iron is centered with respect to the valve housing via the front cone connection.

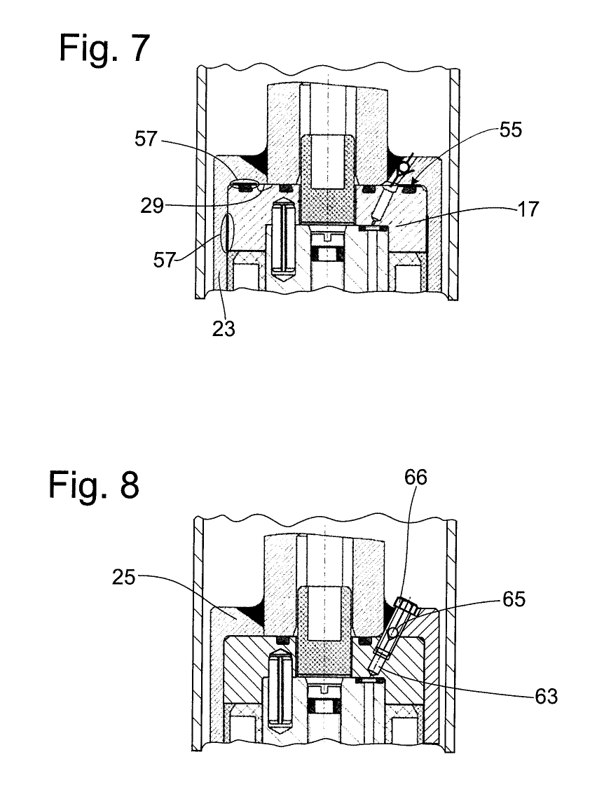

FIG. 7 shows that the back iron 17 can also be fixed radially without play in the valve housing 13 by a glue connection 57. For example, the glue connection 57 is carried out between the end face 55 of back iron 17 and the base surface 19 of valve housing 23. Alternatively, the glue connection 57 can also be closed between the inner wall 33 and the lateral surface of the back iron 17.

FIG. 1 shows a back space 59 between the armature 19 and the pole element 47. At least one connection channel 61 is formed in the pole element 47 and is connected in turn with a flow-off orifice 63 in the back iron. The flow-off orifice 63 adjoins a check valve 65 which carries off gas that may have collected inside of the damping valve device 3 into the working chamber 9 on the piston rod side via the check valve 65. FIG. 8 shows a section of the damping valve device 3 in the area of the flow-off orifice 63. In contrast to FIG. 1, separate fasteners 66 are used between the base 25 of the valve housing 23 and the back iron 17. The fasteners 66 are preferably formed by a screw valve which is screwed into the back iron 17. With regard to the narrow radial installation space, a larger radial installation space is not necessary in practice to enable use of the screw valve 65.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A damping valve device comprising:
a valve housing;
an actuator having a magnetic flux circuit comprising:
a coil arrangement; and
a back iron fixed in radial direction inside the valve housing so as to be free of play and which is separate from the valve housing; and
at least one damping valve configured to be adjusted by the actuator.

13. The damping valve device according to claim 12, wherein the back iron forms an interference fit with an inner wall of the valve housing.

14. The damping valve device according to claim 13, wherein the valve housing has a fitting surface that is offset relative to a rest of the inner wall.

15. The damping valve device according to claim 13, wherein the back iron has areas with different radial elasticity, wherein the interference fit is formed by an area with a greatest radial elasticity.

16. The damping valve device according to claim 13, wherein the interference fit is formed by a lateral surface region of the back iron that extends from an end area of the back iron.

17. The damping valve device according to claim 12, wherein the back iron and the valve housing form a cone connection.

18. The damping valve device according to claim 17, wherein the cone connection is formed by a lateral surface of the back iron extending in circumferential direction.

19. The damping valve device according to claim 17, wherein the cone connection is formed by an end face of the back iron.

20. The damping valve device according to claim 12, wherein the back iron is fixed in the valve housing by a glue connection.

21. The damping valve device according to claim 12, wherein at least one separate fastener is arranged between the valve housing and the back iron.

22. The damping valve device according to claim 21, wherein the at least one separate fastener is formed by a screw valve.
